(19) United States
(12) Patent Application Publication
(10) Pub. No.: US 2025/0053182 A1
(43) Pub. Date: Feb. 13, 2025

(54) Method and Apparatus for Automatic Self Calibration of Mass Flow Controller

(71) Applicant: MKS Instruments, Inc., Andover, MA (US)

(72) Inventor: Junhua Ding, Boxborough, MA (US)

(21) Appl. No.: 18/448,791

(22) Filed: Aug. 11, 2023

(51) Int. Cl. G05D 7/06

(52) U.S. Cl. CPC G05D 7/0623; G05D 7/0635

(57) ABSTRACT

A mass flow controller and methods of providing for mass flow control are provided. A mass flow controller includes a control valve configured to control flow of a fluid in a flow path. A first flow sensor detects a first set of fluid flow parameters, and a second flow sensor detects a second set of fluid flow parameters. The first and second flow sensors are of distinct flow measurement types. The mass flow controller further includes a controller configured to determine a set of first mass flow rates based on the first set of fluid flow parameters detected by the first flow sensor and calibrate the second flow sensor based on the determined set of mass flow rates of the first mass flow sensor and the second set of fluid flow parameters.

### BACKGROUND

Mass flow controllers (MFCs) are components of gas delivery systems that typically require periodic verification and calibration to ensure that precise gas delivery is maintained for semiconductor manufacturing processes.

Traditionally, MFCs are removed from the tool system for verification and calibration, which can require considerable downtime and financial loss.

### SUMMARY

Mass flow control devices and methods are provided which are capable of self-calibration in real-time for advanced semiconductor manufacturing. Such devices and methods can make use of distinct flow measurements and a self-calibration algorithm that can be applied in situ to calibrate a less-accurate sensor with respect to a more-accurate sensor.

A mass flow controller includes a control valve configured to control flow of a fluid in a flow path and first and second flow sensors of distinct flow measurement types. The first flow sensor detects a first set of fluid flow parameters, and the second flow sensor detects a second set of fluid flow parameters. The mass flow controller further includes a controller configured to determine a set of first mass flow rates based on the first set of fluid flow parameters detected by the first flow sensor and calibrate the second flow sensor based on the determined set of mass flow rates of the first mass flow sensor and the second set of fluid flow parameters.

The controller may be configured to calibrate the second flow sensor by:
a) controlling flow with either the first flow sensor or the second flow sensor to a set of calibration flow setpoints; and
b) collecting calibration data of the first flow sensor and the second flow sensor at the set of calibration flow setpoints;
the controller being configured to subsequently control mass flow with the second flow sensor calibrated with the calibration data.

The controller may be configured to calibrate either the second flow sensor in response to a command from a host processor.

The controller can be configured to detect each parameter of the first and second sets of fluid flow parameters during stable fluid flow. The first flow sensor can be, for example, a rate of pressure decay flow sensor (e.g., a pressure sensor associated with a chamber defining a volume for rate of pressure decay measurement). The second flow sensor can be, for example, a pressure sensor adjacent to a flow restrictor disposed in the flow path (e.g., such as for pressure sensing for critical flow measurement). One of the first and second flow sensors can be, for example, a thermal flow sensor. Where a thermal flow sensor is included, the other of the first and second flow sensors can be a rate of pressure decay flow sensor (e.g., a pressure sensor associated with a chamber defining a volume for rate of pressure decay measurement) or a critical flow sensor (e.g., a pressure sensor adjacent to a flow restrictor disposed in the flow path).

The controller can be configured to calibrate the second flow sensor by determining coefficients or constructing a look-up table for a flow rate function associated with the second flow sensor. The function can comprise a critical flow function, a thermal flow function, or a rate of pressure decay function. The controller can be further configured to control actuation of the control valve based on the calibrated second flow sensor.

The mass flow controller can further include a flow body or housing in which the control valve and the first and second mass flow sensors are disposed.

A method of providing for mass flow control includes determining a first set of mass flow rates based on a first set of fluid flow parameters detected by a first flow sensor of a fluid flowing in a flow path. The flow of fluid in the flow path is controlled by a control valve. The method further includes calibrating a second flow sensor based on the determined set of mass flow rates of the first mass flow sensor and a second set of fluid flow parameters detected by the second flow sensor. The first and second flow sensors are of distinct flow measurement types (e.g., rate of pressure decay type, critical flow type, differential pressure based flow type, and thermal flow type, etc.).

Each parameter of the first and second sets of fluid flow parameters can be detected during stable or steady state fluid flow. Calibrating the second flow sensor can include determining coefficients or constructing a look-up table for a flow rate function associated with the second flow sensor. The method can further include controlling actuation of the control valve based on the calibrated one of the first and second mass flow sensing modules.

The method may comprise:
a) controlling flow with either the first flow sensor or the second flow sensor to a set of calibration flow setpoints;
b) collecting calibration data of the first flow sensor and the second flow sensor at the set of calibration flow setpoints; and
c) subsequently controlling mass flow with the second flow sensor calibrated with the calibration data.

The method may further comprise calibrating the second flow sensor in response to a command from a host processor.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic of an example self-calibrating mass flow controller.

FIG. 2 is a schematic of another example of a self-calibrating mass flow controller.

FIG. 3 is a flow diagram of an example method of calibrating the mass flow controller of FIG. 1 or FIG. 2.

### DETAILED DESCRIPTION

A description of example embodiments follows.

Mass flow control (MFC) devices capable of self-calibration and self-calibration methods for MFCs are provided.

An MFC typically includes a system controller as part of a feedback control system that provides a control signal to a control valve as a function of a comparison of the flow rate as dictated by a setpoint with a measured flow rate. The feedback control system thus operates the flow control valve to maintain the measured flow rate at the setpoint flow rate. In a traditional MFC, the feedback control system assumes that the MFC remains in calibration within certain tolerances. To test whether an MFC is within the tolerances of calibration, an MFC may be periodically verified, such as with a mass flow verifier (MFV). If mass flow measurements obtained by the MFC are not within a certain tolerance, the MFC can require recalibration, a process which typically occurs offline and, thus, requires removal of the MFC from the system. The downtime incurred due to removal of an MFC for recalibration can be costly and is undesirable. There exists a need for improved MFC devices that are capable of self-calibration such that the MFC need not be removed from a system for a recalibration process to be performed.

MFC devices comprising two distinct mass flow measurement mechanisms can provide for self-calibration. For example, one of the two mass flow measurement mechanisms can be of a type that generally provides for more accurate mass flow measurement yet may be undesirable for use as the control mechanism for some applications. In such situations, the first of the two mass flow control mechanisms can be used to provide mass flow measurements that are used to calibrate the sensor(s) of the other of the two mass flow measurement mechanisms. An automatic self-calibration procedure can be applied in situ to the less-accurate of the mass flow measurement mechanisms to bring its accuracy on par with the more-accurate mass flow measurement mechanism.

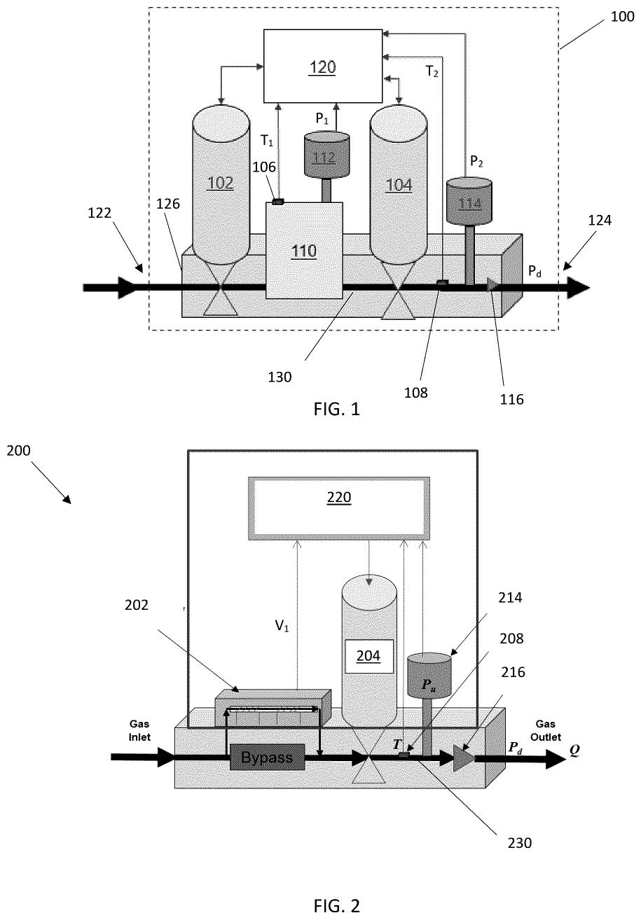

An example configuration of a mass flow controller capable of self-calibration is shown in FIG. 1. A mass flow controller 100 receives a flow of a fluid at an inlet 122, and the fluid flows through a body 126 of the device. The MFC 100 includes an upstream valve 102 and a downstream valve 104. As illustrated, both valves 102, 104 are adjustable control valves; however, the upstream valve 102 can alternatively be an on/off-type valve.

As used herein, the term “control valve” refers to a valve that can provide for a controllable range of open states, likely between on and off states, and excludes on/off-type valves. The openness of an adjustable control valve can be controlled in response to a control signal, and a flow rate through the valve can be controlled. Adjustable control valves include proportional control valves. Examples of suitable control valves for use as an adjustable control valve in the provided devices include solenoid valves, piezo valves, and step motor valves.

The MFC further includes a chamber 110, a temperature sensor 106 that detects a temperature of a fluid in the chamber 110, and a pressure sensor 112 that detects fluid pressure in the chamber 110. The chamber 110 is disposed or part of the body 126 between the upstream valve 102 and the downstream control valve 104 and is provided for rate of pressure decay measurements. The MFC further includes a flow restrictor 116, such as a critical flow nozzle or an orifice. A second pressure sensor 114 and, optionally, a second temperature sensor 108 are disposed downstream of the control valve 104 and upstream of the critical flow nozzle 116. The second pressure sensor 114 is provided for pressure measurements. Fluid flows through a flow path 130 and out of the MFC at an outlet 124.

The MFC 100 further includes a controller 120, which can receive sensed temperature and pressure information from sensors 106, 108, 112, 114 and provide control signals to operate valves 102 and 104 to regulate pressure and/or flow of the fluid through the flow path 130 to a setpoint. The MFC 100 can obtain flow measurements using either or both a rate of pressure decay and critical flow measurement methods. Rate of pressure decay methods are generally more accurate and have the advantage of being inherently gas independent; however, such methods can be limited to low-flow control applications due to volume limitations of the chamber 110 and can be inefficient in some circumstances.

In the example configuration shown in FIG. 1, the pressure sensor 112, which is configured for detection of rate of pressure decay measurements, provides for one measurement type, and the pressure sensor 114, which is configured for detection of pressure under critical flow conditions, provides for another measurement type. In such a configuration, the sets of fluid flow parameters that are detected can include pressure measurements of fluid flowing in the flow path 130.

With the MFC configuration shown in FIG. 1, a rate of pressure decay flow measurement (Q1) based on pressure measurements from sensor 112 can be used as a flow calibration standard to calibrate a critical flow measurement (Q2) based on pressure measurements from sensor 114.

A calibration procedure can be performed to determine function coefficients and/or to construct a calibration table. For example, a first flow measurement, based on the rate of pressure decay principal, can be calculated as a function of the pressure measurement (P₁) obtained from sensor 112, as follows, where k0 and k1 are constants at a constant temperature:

$$Q 1 = fd ( {P}_{1} ) = k 0 + k 1 \frac{{dP}_{1}}{dt} \qquad ( 1 )$$

A second flow measurement, based on the critical flow principle, can be calculated as a function of the pressure measurement (P₂) obtained from sensor 114, as follows, where C0 and C1 are constants:

$$Q 2 = fp ( {P}_{2} ) = C 0 + C 1 * {P}_{2} \qquad ( 2 )$$

A flow calibration process can determine a relationship between the input signal (P₂) and the output signal (Q2) for the second measurement method using the flow measurement (Q1) obtained from the first method.

While the above example describes a rate of pressure decay measurement being used as the flow-calibration standard, it is possible for the critical flow-based measurement to be used as the calibration standard instead, for example, to calibrate the flow rate measured by the rate of pressure decay method using pressure sensor 112.

Methods of determining a mass flow rate of a fluid based on pressures sensed upstream (and optionally downstream) of a flow restrictor are generally known in the art. The flow restrictor can be of any suitable type for restricting a flow of the fluid, including, for example, a critical flow nozzle, a laminar flow element, a porous media flow restrictor, an orifice, a valve, or a tube.

Another example configuration of a mass flow controller capable of self-calibration is shown in FIG. 2. The mass flow controller 200 includes a thermal flow sensor 202, a control valve 204, and a pressure sensor 214. The pressure sensor 214 is disposed downstream of the control valve 204 and upstream of a flow restrictor 216, such as a critical flow nozzle. The flow of fluid through a flow path 230 of the device is controlled by the control valve 204. A controller 220, such as a micro-processor, can control actuation of the control valve 204 based on either or both of a monitored mass flow (V₁), as sensed by the thermal flow sensor 202, and a monitored pressure (Pᵤ), as sensed by the pressure sensor 214, either of which can be regulated to a setpoint.

Thermal flow sensors typically include a heat source, over which the gas being measured passes, and operate based on temperature measurements obtained of the gas. For example, a thermal flow sensor can include a sensor tube at which thermal elements are disposed. The thermal elements can be, for example, coiled resistors, which wrap around the sensor tube and are heated to a temperature above the ambient temperature. As gas flows through the sensor tube, the gas, which is typically at ambient temperature, has a cooling effect on the coils and lowers their temperature as a function of mass flow. The flowing gas cools an upstream coil more than a downstream coil and, thus, a mass flow rate of the gas can be determined based on a measured temperature difference between the coils, as indicated by a measured difference in resistances between the coils. Examples of thermal flow sensors are further described in U.S. Pat. No. 5,461,913.

Thermal flow sensors can be advantageous for use in mass flow control applications, but can be unsuitable for some applications (e.g., such as with reactive gases) and can be prone to drift.

In the example configuration shown in FIG. 2, the thermal flow sensor 202 provides for one measurement type, and the pressure sensor 214, which is configured for detection of pressure under critical flow conditions, provides for another flow measurement type. In such a configuration, the sets of fluid flow parameters that are detected can include mass flow rate measurements based on voltage outputs of the thermal pressure sensor and pressure measurements of fluid flowing in the flow path 130.

With the MFC configuration shown in FIG. 2, one of a pressure based critical flow measurement and a thermal flow based measurement can be used as the calibration standard to calibrate the other of the two sensors. For example, a first flow measurement based on thermal mass flow sensor can be calculated as a function of an output voltage (V₁) of a thermal mass flow sensor (e.g., sensor 202), as follows, where k0 and k1 are constants:

$$Q 1 = ft ( V 1 ) = k 0 + k 1 * V 1 \qquad ( 3 )$$

A second mass flow measurement, based on the critical flow principle, can be calculated as in Eqn. 2. Where the thermal flow based measurement is used as the standard, a flow calibration process can determine a relationship between the input signal (P₂) and the output signal (Q2) for the second measurement method using the flow measurement (Q1) obtained from the first method. Where the pressure based critical flow measurement is used as the calibration standard, a relationship between the input signal (V₁) and the output signal (Q1) of the thermal mass flow reading can be determined using the flow measurement (Q2) from the critical flow method.

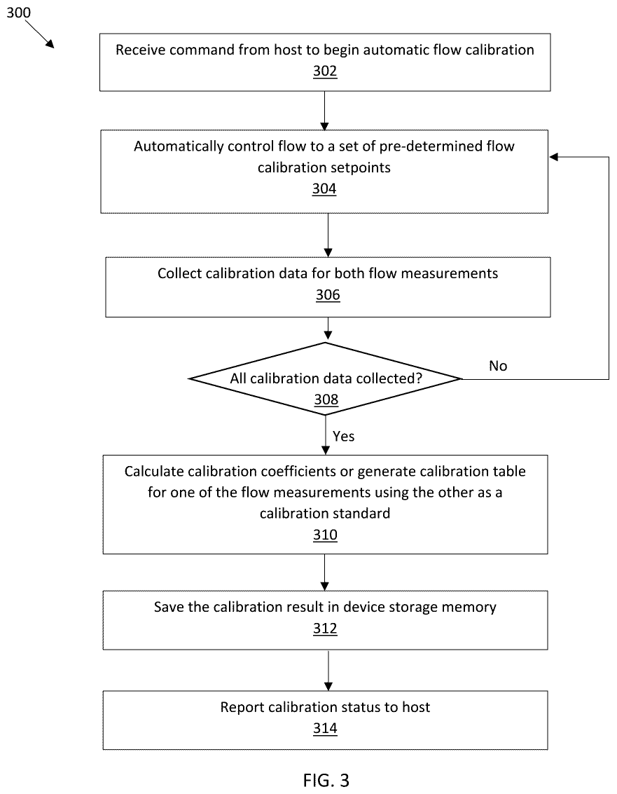

An example MFC calibration procedure 300 is shown in FIG. 3. Upon receiving a command from a host processor to perform “automatic flow calibration” (302), a controller of the MFC (e.g., controller 120, 220) can control the flow to a set of predetermined setpoints (SP (i)), e.g., 5% FS, 10% FS, 15% FS, 20% FS, . . . , 100% FS (304), where FS is full scale flow of the MFC. Either Q1 or Q2 can be used for flow control in the MFC closed-loop control. When the flow is settled at a calibration setpoint SP (i), the corresponding measurements, e.g. [Q1, dP1/dt, Q2, P₂] i, are recorded as the calibration data for one setpoint (306). When a complete data set {[Q1, dP1/dt, Q2, P₂] _i} is collected (308), calibration coefficients can be determined and/or calibration tables can be constructed (310).

For example, with the MFC 100 shown in FIG. 1, in the case of using the rate of pressure decay flow measurement Q1 as the flow standard, the MFC can either determine the coefficients of Eqn. 2 or construct a calibration lookup table between the input pressure measurement P₂ and the output flow measurement Q2 based on the collected calibration data set.

For example, we can construct and then use a [P2 Q2] look-up table to calculate Q2. To construct the calibration lookup table for Q2 using Q1 as the standard, either Q1 or Q2 is used to control to each of the flows at the predetermined setpoints. At each flow setpoint, the measured Q1 is used as Q2 in the [P2 Q2] lookup table with the pressure P2 measured at that flow. Using simple pressure and flow examples, the lookup table [P2 Q2] might be:

$$[ \begin{matrix}10 & 1\end{matrix} ]$$

$$[ \begin{matrix}20 & 2\end{matrix} ]$$

$$[ \begin{matrix}30 & 3\end{matrix} ]$$

$$:$$

$$:$$

$$:$$

$$[ \begin{matrix}100 & 10\end{matrix} ]$$

The first column is the pressure in Torr and the second column is the flow rate in sccm. If a measured P2 at the third setpoint of 3 sccm is 30 Torr, then the look-up table gives [30 3] as the third entry of the table. With the table fully constructed through all setpoints and, after calibration, P2 is used to measure and control flow, a measured 30 Torr directly measures 3 sccm. If a measured P2 is 25 Torr, then the flow is 2.5 sccm using a linear interpolation in the calibration look-up table. Of course, we can instead use Eq. (2) with calibrated coefficients C0 and C1 to directly calculate Q2. In the above case, Q2=C0+C1*P2=0.1*P₂ where C0=0, C1=0.1. The coefficients or parameters of C0 and C0 can be estimated using a least squares regression method on a calibration data set like the above look-up table.

Thus, if we have the calibration data set as {P2 (i), Q2 (i)} where i=1, 2, . . . ,n, we can either construct a lookup table or estimate parameters in Eq. (2), i.e. C0 and C1, for flow calculation from P2. The automatic self-calibration procedure is to control the flow to a set of calibration flow setpoints using the standard, here Q1, and thus obtain the required calibration data set, e.g. {P2 (i), Q2 (i)}.

In the case of using the critical flow measurement Q2 as the flow standard, the MFC can either determine the coefficients of Eqn. 1 or construct a calibration lookup table between the input pressure measurement dP₁/dt and the output flow measurement Q1 based on the collected calibration data set.

In another example, with the MFC 200 shown in FIG. 2, when the flow is settled at a calibration setpoint, the corresponding measurements e.g. [Q1, V1, Q2, P₂] i, are recorded as the calibration data for one setpoint (306). When a complete data set {[Q1, V1, Q2, P₂] _i} is collected (308), calibration coefficients can be determined and/or calibration tables can be constructed (310). In the case of using the thermal flow measurement Q1 as the flow standard, the MFC can either determine the coefficients of Eqn. 2 or construct a calibration lookup table between the input pressure measurement P₂ and the output flow measurement Q2 based on the collected calibration data set. In the case of using the critical flow measurement Q2 as the flow standard, the MFC can either determine the coefficients of Eqn. 3 or construct a calibration lookup table between the input pressure measurement V1 and the output flow measurement Q1 based on the collected calibration data set.

In any configuration, the calibration result can be saved in the MFC's storage memory (312), e.g. flash memory or EEPROM memory etc. The MFC can report back to the host processor that the automatic flow calibration has completed (314) and the device is ready for use.

An advantage of the configurations and methods described above is that the flow is stabilized to a setpoint as calibration measurements are obtained with both measurement modules (e.g., Q1 and Q2 can be concurrently obtained at a stable flow).

The MFC devices and methods described can provide for several advantages. In particular, the provided devices and methods simplify MFC maintenance and enable it to occur on the process tool, i.e. in situ self-calibration. Avoiding the downtime that occurs when an MFC is removed from the process tool can provide for significant financial savings. The provided devices and methods can also improve the accuracy of an MFC as it is operating on the process tool, particularly for the processing gas that is in use at the time of calibration. A self-verification baseline can be aligned when the MFC is reset upon calibration.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A mass flow controller comprising:
a control valve configured to control flow of a fluid in a flow path;
a first flow sensor that detects a first set of fluid flow parameters;
a second flow sensor that detects a second set of fluid flow parameters, the first and second flow sensors being of distinct flow measurement types; and
a controller configured to:
determine a set of first mass flow rates based on the first set of fluid flow parameters detected by the first flow sensor; and
calibrate the second flow sensor based on the determined set of mass flow rates of the first flow sensor and the second set of fluid flow parameters.

2. The mass flow controller of claim 1, wherein the controller is configured to detect each parameter of the first and second sets of fluid flow parameters during stable fluid flow.

3. The mass flow controller of claim 1, wherein the first flow sensor is a rate of pressure decay flow sensor.

4. The mass flow controller of claim 3, wherein the second flow sensor comprises a pressure sensor adjacent to a flow restrictor disposed in the flow path.

5. The mass flow controller of claim 1, wherein one of the first and second flow sensors is a thermal flow sensor and the other of the first and second flow sensors comprises a pressure sensor adjacent to a flow restrictor disposed in the flow path.

6. The mass flow controller of claim 1, wherein the controller is configured to calibrate the second flow sensor by:
a) controlling flow with either the first flow sensor or the second flow sensor to a set of calibration flow setpoints; and
b) collecting calibration data of the first flow sensor and the second flow sensor at the set of calibration flow setpoints;
the controller being configured to subsequently control mass flow with the second flow sensor calibrated with the calibration data.

7. The mass flow controller of claim 6, wherein the controller is configured to calibrate the second flow sensor in response to a command from a host processor.

8. The mass flow controller of claim 1, wherein the controller is configured to calibrate the second flow sensor by determining coefficients or constructing a look-up table for a flow rate function associated with the second flow sensor.

9. The mass flow controller of claim 8, wherein the function comprises a critical flow function, a thermal flow function, or a rate of pressure decay function.

10. The mass flow controller of claim 1, wherein the controller is further configured to control actuation of the control valve based on the calibrated second flow sensor.

11. The mass flow controller of claim 1, further comprising a flow body or housing, wherein the control valve and the first and second mass flow sensors are disposed within the flow body or housing.

12. A method of providing for mass flow control comprising:
determining a first set of mass flow rates based on a first set of fluid flow parameters detected by a first flow sensor of a fluid flowing in a flow path, the flow controlled by a control valve; and
calibrating a second flow sensor based on the determined set of mass flow rates of the first mass flow sensor and a second set of fluid flow parameters detected by the second flow sensor, the first and second flow sensors being of distinct flow measurement types.

13. The method of claim 12, wherein each parameter of the first and second sets of fluid flow parameters is detected during stable fluid flow.

14. The method of claim 12, wherein the first flow sensor is a rate of pressure decay flow sensor.

15. The method of claim 14, wherein the second flow sensor comprises a pressure sensor adjacent to a flow restrictor disposed in the flow path.

16. The method of claim 12, wherein one of the first and second flow sensors is a thermal flow sensor and the other of the first and second flow sensors comprises a pressure sensor adjacent to a flow restrictor disposed in the flow path.

17. The method of claim 12, comprising:
a) controlling flow with either the first flow sensor or the second flow sensor to a set of calibration flow setpoints;
b) collecting calibration data of the first flow sensor and the second flow sensor at the set of calibration flow setpoints; and
c) subsequently controlling mass flow with the second flow sensor calibrated with the calibration data.

18. The method of claim 17, further comprising calibrating the second flow sensor in response to a command from a host processor.

19. The method of claim 12, wherein calibrating the second flow sensor comprises determining coefficients or constructing a look-up table for a flow rate function associated with the second flow sensor.

20. The method of claim 19, wherein the function comprises a critical flow function, a thermal flow function, or a rate of pressure decay function.

21. The method of claim 12, further comprising controlling actuation of the control valve based on the calibrated second flow sensor.
